(19) United States
(12) Patent Application Publication
(10) Pub. No.: US 2012/0165058 A1
(43) Pub. Date: Jun. 28, 2012

(54) APPARATUS AND METHOD FOR CONTROLLING RANDOM ACCESS OF MACHINE TYPE COMMUNICATION DEVICE AND WIRELESS COMMUNICATION SYSTEM PROVIDING MACHINE TYPE COMMUNICATION SERVICE

(75) Inventors: You Sun HWANG, Seoul (KR); Kyung Yul CHEON, Daejeon (KR); Soon Yong LIM, Daejeon (KR); Ae Soon PARK, Daejeon (KR)

(73) Assignee: Electronics and Telecommunications Research Institute, Daejeon (KR)

(21) Appl. No.: 13/335,218

(22) Filed: Dec. 22, 2011

(30) Foreign Application Priority Data
Dec. 22, 2010 (KR) 10-2010-0132111

(51) Int. Cl. H04W 72/04

(52) U.S. Cl. 455/509

(57) ABSTRACT

Provided are an apparatus and method for controlling random access of a machine type communication (MTC) device in a wireless communication network providing an MTC service, and a wireless communication system providing an MTC service. The method includes inserting, at a base station, information about a random access preamble group for an MTC device and information about a random access time for an MTC device in system information (SI), and transmitting, at the base station, the SI to at least one MTC device.

### CLAIM FOR PRIORITY

This application claims priority to Korean Patent Application No. 10-2010-0132111 filed on Dec. 22, 2010 in the Korean Intellectual Property Office (KIPO), the entire contents of which are hereby incorporated by reference.

### BACKGROUND

1. Technical Field

Example embodiments of the present invention relate in general to a random access method for a machine type communication (MTC) service in a Third Generation Partnership Project (3GPP) Long Term Evolution (LTE)-Advanced system and a wireless communication apparatus using the same, and more particularly, to an apparatus and method for controlling random access of an MTC device in a wireless communication network providing an MTC service, and a wireless communication system providing an MTC service.

2. Related Art

MTC or machine-to-machine (M2M) communication is a form of data communication which involves one or more entities that do not necessarily need human interaction.

A service optimized for MTC differs from a service optimized for human-to-human communication. In comparison with a current mobile network communication service, the MTC service can be characterized by a) several market scenarios, b) data communications, c) lower cost and less effort, d) a potentially very large number of communicating terminals, e) a wide service area, and f) very low traffic per terminal.

MTC may be implemented in various forms of service, for example, smart metering, tracking and tracing, remote maintenance and control, and e-health.

Lately, 3GPP has also been working on MTC standardization for intelligent communication between a human and an object and between objects. For various types of MTC applications having main functions of smart metering, remote control, etc., a huge number of MTC devices are disposed and managed.

In 3GPP LTE systems, either of an MTC device and general terminal is treated as one user equipment (UE) and needs to be individually registered in an LTE network. The disposition of multiple MTC devices causes scheduling competition for channel allocation, exhaustion of radio resources, overload resulting from signal generation, and so on, thereby exerting a bad influence on existing general terminals. With an emphasis put on minimization of the adverse effect caused by the disposition of MTC devices, 3GPP has been working on standardization.

Basically, a terminal of a 3GPP LTE-Advanced system should receive uplink timing information from a base station to perform synchronization, or should perform a random access procedure to control and set power for initial uplink transmission or transmit a user message.

Existing 3GPP LTE-Advanced systems have a standard of a random access procedure for a general terminal. However, there is no clear standard for a random access procedure in which an MTC service is taken into consideration, and a random access procedure for an MTC device is necessary.

### SUMMARY

Accordingly, example embodiments of the present invention are provided to substantially obviate one or more problems due to limitations and disadvantages of the related art.

Example embodiments of the present invention provide a random access method for a machine type communication (MTC) service based on an existing random access procedure in a mobile communication system based on Third Generation Partnership Project (3GPP) Long Term Evolution (LTE), and a wireless communication apparatus using the random access method.

In some example embodiments, a method of controlling random access of an MTC device in a wireless communication network includes: inserting, at a base station, information about a random access preamble group for an MTC device and information about a random access time for an MTC device in system information (SI); and transmitting, at the base station, the SI to at least one MTC device.

The SI may be a system information block type 2 (SIB2).

The information about a random access preamble group for an MTC device may be included in random access channel (RACH) common configuration (RACH-ConfigCommon) information as one field.

The RACH common configuration information may be included in a common radio resource configuration (radioResourceConfigCommon) of the SIB2 as one information element (IE).

The information about a random access time for an MTC device may be included in the SIB2 as one IE.

The SIB2 may be transmitted to the at least one MTC device in the form of a radio resource control (RRC) message.

The method may further include: receiving, at the MTC device, the SI from the base station; extracting, at the MTC device, the information about a random access preamble group for an MTC device and the information about a random access time for an MTC device from the SI; and transmitting, at the MTC device, a random access preamble at a point in time depending on the information about a random access time for an MTC device using the information about a random access preamble group for an MTC device.

In other example embodiments, an apparatus for controlling random access of an MTC device in a wireless communication network providing an MTC service inserts information about a random access preamble group for an MTC device and information about a random access time for an MTC device in SI, and transmits the SI to at least one MTC device.

The SI may be an SIB2, and the information about a random access preamble group for an MTC device may be included in RACH common configuration (RACH-ConfigCommon) information, which is one IE in a common radio resource configuration (radioResourceConfigCommon) of the SIB2, as one field.

The information about a random access time for an MTC device may be included in the SIB2 as one IE.

In other example embodiments, an MTC device communicates with a base station in a wireless communication network providing an MTC service, receives SI including information about a random access preamble group for an MTC device and information about a random access time for an MTC device from the base station, extracts the information about a random access preamble group for an MTC device and the information about a random access time for an MTC device from the SI, and transmits a random access preamble at a point in time depending on the information about a random access time for an MTC device using the information about a random access preamble group for an MTC device.

In other example embodiments, a wireless communication system providing an MTC service includes: a base station configured to insert information about a random access preamble group for an MTC device and information about a random access time for an MTC device in SI, and transmit the SI to at least one MTC device; and an MTC device configured to receive the SI from the base station, extract the information about a random access preamble group for an MTC device and the information about a random access time for an MTC device from the SI, and transmit a random access preamble at a point in time depending on the information about a random access time for an MTC device using the information about a random access preamble group for an MTC device.

The SI may be an SIB2 and transmitted to the at least one MTC device in the form of an RRC message.

### BRIEF DESCRIPTION OF DRAWINGS

Example embodiments of the present invention will become more apparent by describing in detail example embodiments of the present invention with reference to the accompanying drawings, in which:

FIG. 1 illustrates a random access procedure of a general terminal in a Third Generation Partnership Project (3GPP) Long Term Evolution (LTE)-Advanced system;

FIG. 2 illustrates a wireless communication network that provides a machine type communication (MTC) service to which example embodiments of the present invention are applied;

FIG. 3 shows information elements (IEs) included in a system information block type 2 (SIB2) according to an example embodiment of the present invention;

FIG. 4 shows fields included in a random access channel (RACH) common configuration according to an example embodiment of the present invention; and

FIG. 5 illustrates a random access procedure of an MTC device according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The term “terminal” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

The term “base station” used herein generally denotes a fixed point communicating with a terminal, and may be referred to as a Node-B, evolved Node-B (eNB), base transceiver system (BTS), access point (AP), and other terms.

Hereinafter, example embodiments of the present invention will be described in detail with reference to the appended drawings. To aid in understanding the present invention, like numbers refer to like elements throughout the description of the figures, and the description of the same component will not be reiterated.

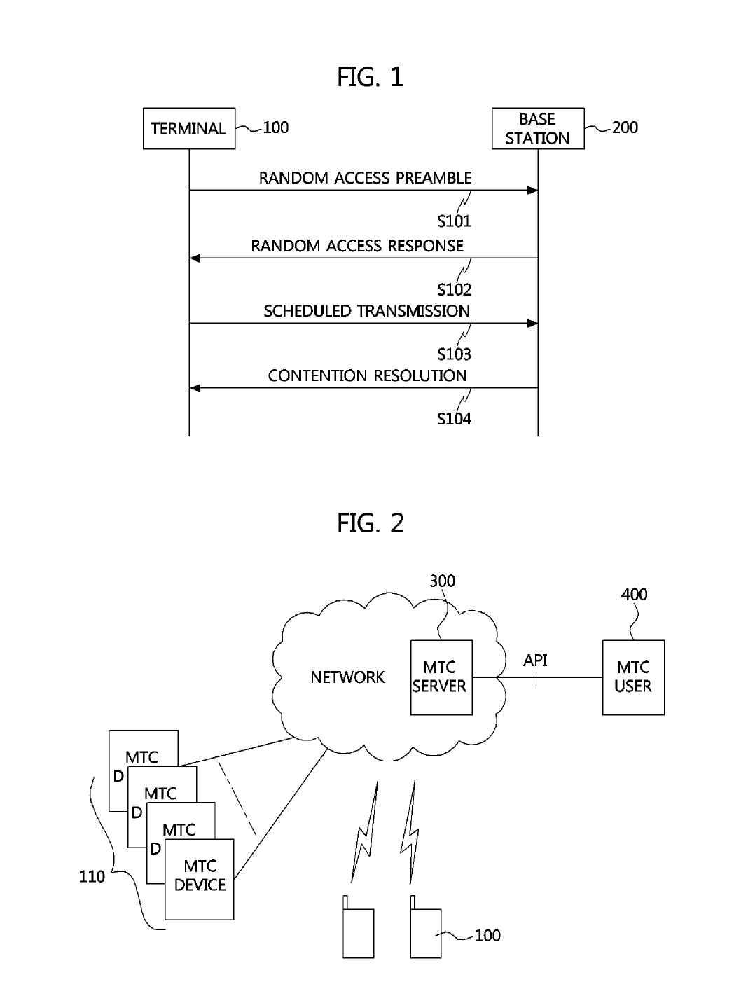

FIG. 1 illustrates a random access procedure of a general terminal in a Third Generation Partnership Project (3GPP) Long Term Evolution (LTE)-Advanced system.

As a process for a terminal to access a network, a random access procedure is performed in the cases of initial access, handover, scheduling request, uplink time synchronization, and so on. In other words, all terminals perform random access for initial access and data transmission.

Random access procedures may be classified into a contention-based access procedure and a non-contention-based access procedure. The contention-based access procedure will be described with reference to FIG. 1. In the contention-based random access procedure, a random one of a plurality of random access preambles used in common is selected and used, which may lead to collisions with other terminals.

Referring to the random access procedure illustrated in FIG. 1, a terminal 100 randomly selects a random access preamble using random access-related system information (SI) that has been received from a base station 200 in advance, and transmits the selected preamble to the base station 200 (S101).

The base station 200 receives the preamble from the terminal 100, and transmits a random access response message to the terminal 100 (S102).

When the random access response message is successfully received in response to the preamble that has been transmitted by the terminal 100 itself, the terminal 100 performs scheduled uplink transmission using uplink radio resources allocated by the base station 200 to set a radio resource control (RRC) connection (S103). The base station 200 receiving transmits a contention-resolution message as a response to the uplink transmission from the terminal (S104), and the random access procedure is completed when the terminal 100 receives the competition resolution message.

In a machine type communication (MTC) service, multiple random access procedures may be caused at the same time by many MTC devices due to unique characteristics of the MTC service. Also, if an MTC device uses the procedure of FIG. 1 used by general terminals to gain access in a 3GPP LTE system, the MTC device needs to compete with a general terminal.

In other words, when selecting a random access preamble, a general terminal determines a group to select using information received through SI, and randomly determines a value in the group, thereby accessing a base station.

Here, the SI includes information about random access preamble selection, and in a 3GPP LTE system, a base station includes common channel-related information and overall information about the system in the SI and transmits the SI to terminals through a common broadcast channel.

To transfer SI, three types of RRC messages are used, which are a master information block (MIB) message, a system information block type 1 (SIB1) message, and an SI message.

SI is configured in the form of an SIB, and each SIB includes a series of functionally-related parameters. According to characteristics, SIBs may be classified into an MIB including a limited number of parameters that are most frequently transmitted as parameters necessary for a terminal to initially access a network, an SIB1 including parameters needed to determine whether the corresponding cell is appropriate for cell selection and information related to time domain scheduling of other SIBs, a system information block type 2 (SIB2) including information about a shared common channel, and so on.

Segmentation and concatenation of SIBs are performed in an RRC layer. SIBs having similar characteristics are grouped together, and scheduling of a transmission period or method, etc. is managed in units of groups.

After receiving such SI, a terminal sets a channel, analyzes information about a random access channel to perform initial random access, and then starts a random access procedure by selecting one of available random access preambles.

FIG. 2 illustrates a wireless communication network that provides an MTC service to which example embodiments of the present invention are applied. As illustrated in FIG. 2, a wireless communication network providing an MTC service includes an MTC server 300 for providing the MTC service, MTC devices 110, an MTC user 400, etc. in addition to an existing wireless communication network.

The MTC devices 110 are UEs having an MTC communication function of communicating with the MTC server 300 and each other via a public land mobile network (PLMN).

The MTC server 300 communicates with the PLMN, and communicates with the MTC devices 110 via the PLMN. Also, the MTC server 300 has an interface that can be accessed by the MTC user 400, and provides service for the MTC user 400. The MTC user 400 uses the service provided by the MTC server 300.

In the constitution of FIG. 2, the MTC server 300 is controlled by a network operator. The network operator provides an application programming interface (API) on the MTC server 300, and the MTC user 400 accesses the MTC server 300 of the network operator through the API.

In FIG. 2, an MTC server is included in a network operator domain, but may be located not in the network operator domain but outside the network operator domain. In this case, the MTC server is not controlled by a network operator.

Also, the MTC devices 110 communicate with the MTC server 300, etc. present in the network through a base station (not shown), which is an apparatus for controlling random access of an MTC device according to an example embodiment of the present invention.

In other words, as an apparatus for controlling random access of an MTC device in a wireless communication network providing an MTC service according to an example embodiment of the present invention, the base station inserts information about a random access preamble group for an MTC device and information about a random access time for an MTC device in SI, and transmits the SI to at least one MTC device.

In an example embodiment of the present invention implemented through such an MTC communication network, information about an MTC group corresponding to a random access preamble for an MTC device and information about a time to perform random access are added to SI, so that competition between the MTC device and general terminals can be reduced using a characteristic that the MTC device wakes up at a predetermined time to perform random access.

When there is data to be transmitted, an MTC device in an idle state performs a random access procedure to perform uplink channel synchronization with a base station. In an example embodiment of the present invention, an MTC device is informed of information about a time for a random access procedure and information about a random access preamble group through SI, particularly, an SIB2.

The information about a random access preamble group is added to a random access channel (RACH) configuration (RACH-Config) of a radio resource common configuration (radioResourceConfigCommon).

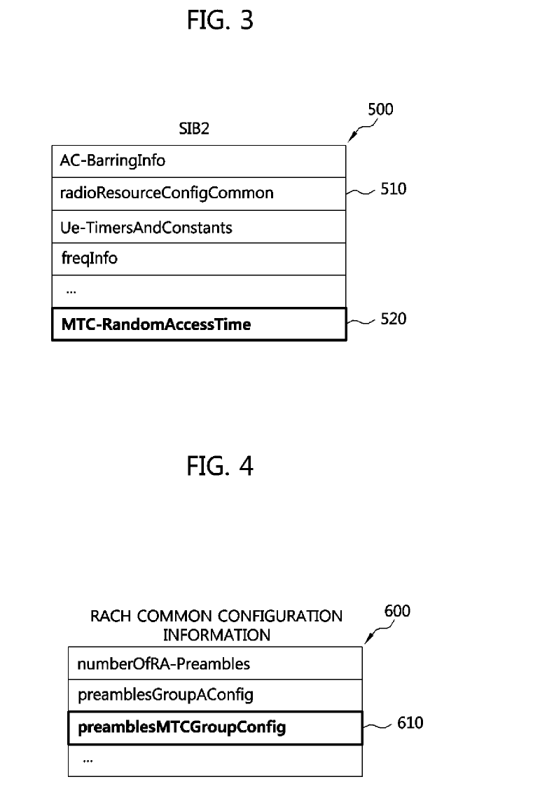

FIG. 3 shows information elements (IEs) included in an SIB2 according to an example embodiment of the present invention.

As shown in FIG. 3, an SIB2 includes IEs such as information about access class barring (AC-BarringInfo), a common radio resource configuration (radioResourceConfigComm), UE-timers and constants (UE-TimersAndConstants), frequency information (freqInfo), and so on.

The SIB2 according to an example embodiment of the present invention also includes an IE of an MTC random access time 520. The MTC random access time 520 indicates information about a time for an MTC device to perform random access.

An IE of a common radio resource configuration 510 is used to define a common radio resource configuration in mobility control information. The IE of the common radio resource configuration 510 may include IEs such as a RACH common configuration (RACH-ConfigComm), a physical RACH configuration (PRACH-Config), a physical downlink shared channel (PDSCH) common configuration (PDSCH-ConfigCommon), a physical uplink shared channel (PUSCH) common configuration (PUSCH-ConfigCommon), a physical hybrid automatic repeat request (HARQ) indicator channel (PHICH) configuration (PHICH-Config), and a physical uplink control channel (PUCCH) configuration (PUCCH-ConfigCommon).

“RACH common configuration” IE according to an example embodiment of the present invention may include IEs as shown in FIG. 4.

FIG. 4 shows fields included in a RACH common configuration according to an example embodiment of the present invention.

It has been described above with reference to FIG. 3 that a RACH common configuration is included in a common radio resource configuration.

A RACH common configuration (RACH-ConfigCommon) is used to define unique random access parameters, and as shown in FIG. 4, may include a field of the number of random access preambles (numberOfRA-Preambles) and a field of a configuration of preamble group A (preamblesGroupAConfig).

Also, a random access common configuration 600 according to an example embodiment of the present invention includes a random access preamble group field 610 for an MTC device. The random access preamble group field 610 for an MTC device includes information about a random access preamble group to be used by the MTC device in a random access procedure.

Here, the number of random access preambles indicates the number of non-dedicated random access preambles, and is expressed by an integer. Also, the configuration of preamble group A provides a configuration for preamble grouping. When the field of the configuration of preamble group A is not signaled, the size of random access preamble group A is the same as the number of random access preambles.

In addition to these fields, the IE of the random access common configuration 600 may further include several fields.

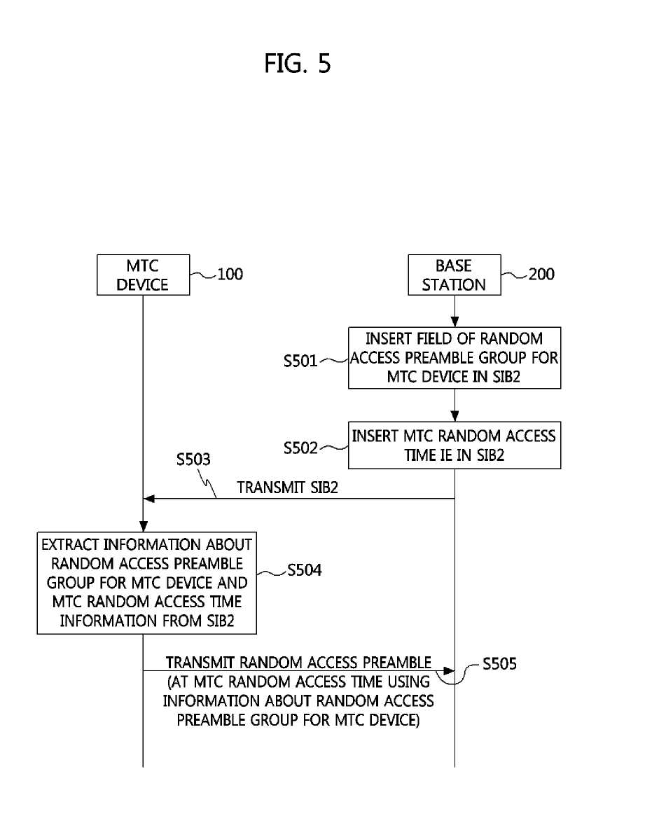

FIG. 5 illustrates a random access procedure of an MTC device according to an example embodiment of the present invention.

A base station 200 inserts a random access preamble group field for an MTC device in an SIB2 (S501). Specifically, the base station 200 configures a random access channel common configuration IE including a field of a random access preamble group for an MTC device, and includes the configured random access channel common configuration IE in a common radio resource configuration IE, thereby generating an SIB2.

Also, the base station 200 inserts an MTC random access time IE in the SIB2 (S502). Here, S501 and S502 may be performed in the reverse order.

The base station 200 transmits the generated SIB2 (S503), and an MTC device 110 receives the SIB2. At this time, the SIB2 is transmitted in the form of an RRC message.

The MTC device 110 receiving the SIB2 according to an example embodiment of the present invention extracts information about a random access preamble group for an MTC device and MTC random access time information (S504).

The MTC device 110 transmits a random access preamble at a point in time depending on the MTC random access time information received from the base station 200 using the information about a random access preamble group for an MTC device (S505). Subsequent procedures are the same as random access procedures of a general terminal, and thus additional description will be omitted (not shown).

In brief, example embodiments of the present invention add a random access preamble group and a time for an MTC device to SI and transmit the SI to support a random access procedure of the MTC device, thereby preventing as many random access collisions between general terminals and the MTC device as possible.

In example embodiments of the present invention, a random access preamble group and a time for an MTC device are added to SI on the basis of an existing random access procedure, so that collisions with general terminals can be reduced as much as possible when the MTC device performs a random access procedure in a 3GPP LTE-Advanced system.

While the example embodiments of the present invention and their advantages have been described in detail, it should be understood that various changes, substitutions and alterations may be made herein without departing from the scope of the invention.

What is claimed is:

1. A method of controlling random access of a machine type communication (MTC) device in a wireless communication network providing an MTC service, the method comprising:
inserting, at a base station, information about a random access preamble group for an MTC device and information about a random access time for an MTC device in system information (SI); and
transmitting, at the base station, the SI to at least one MTC device.

2. The method of claim 1, wherein the SI is a system information block type 2 (SIB2).

3. The method of claim 2, wherein the information about a random access preamble group for an MTC device is included as a field in random access channel (RACH) common configuration (RACH-ConfigCommon) information.

4. The method of claim 3, wherein the RACH common configuration information is included, as an information element (IE), in a common radio resource configuration (radioResourceConfigCommon) of the SIB2.

5. The method of claim 2, wherein the information about a random access time for an MTC device is included in the SIB2 as an information element (IE).

6. The method of claim 2, wherein the SIB2 is transmitted to the at least one MTC device in the form of a radio resource control (RRC) message.

7. The method of claim 1, further comprising:
receiving, at the MTC device, the SI from the base station;
extracting, at the MTC device, the information about a random access preamble group for an MTC device and the information about a random access time for an MTC device from the SI; and
transmitting, at the MTC device, a random access preamble at a point in time depending on the information about a random access time for an MTC device using the information about a random access preamble group for an MTC device.

8. An apparatus for controlling random access of a machine type communication (MTC) device in a wireless communication network providing an MTC service, wherein information about a random access preamble group for an MTC device and information about a random access time for an MTC device is inserted in system information (SI), and
the SI is transmitted to at least one MTC device.

9. The apparatus of claim 8, wherein the SI is a system information block type 2 (SIB2).

10. The apparatus of claim 9, wherein the information about a random access preamble group for an MTC device is included, as a field, in a random access channel (RACH)-common configuration (RACH-ConfigCommon), which is one information element (IE) in a common radio resource configuration (radioResourceConfigCommon) of the SIB2.

11. The apparatus of claim 9, wherein the information about a random access time for an MTC device is included in the SIB2 as an information element (IE).

12. A machine type communication (MTC) device communicating with a base station in a wireless communication network providing an MTC service,
wherein system information (SI) including information about a random access preamble group for an MTC device and information about a random access time for an MTC device is received from the base station,
the information about a random access preamble group for an MTC device and the information about a random access time for an MTC device is extracted from the SI, and
a random access preamble is transmitted at a point in time depending on the information about a random access time for an MTC device using the information about a random access preamble group for an MTC device.

13. A wireless communication system providing a machine type communication (MTC) service, comprising:
a base station configured to insert information about a random access preamble group for an MTC device and information about a random access time for an MTC device in system information (SI), and transmit the SI to at least one MTC device; and
an MTC device configured to receive the SI from the base station, extract the information about a random access preamble group for an MTC device and the information about a random access time for an MTC device from the SI, and transmit a random access preamble at a point in time depending on the information about a random access time for an MTC device using the information about a random access preamble group for an MTC device.

14. The wireless communication system of claim 13, wherein the SI is a system information block type 2 (SIB2), and
the SIB2 is transmitted to the at least one MTC device in the form of a radio resource control (RRC) message.
